(19) United States
(12) Patent Application Publication
(10) Pub. No.: US 2026/0353392 A1
(43) Pub. Date: Nov. 5, 2026

(54) Framework for Responding Frames to a Protected Frame

(71) Applicant: Apple Inc., Cupertino, CA (US)

(72) Inventors: Yanjun Sun, San Diego, CA (US); Yoel Boger, Shoham (IL); Anuj Batra, Redwood City, CA (US); Yong Ho Seok, Cupertino, CA (US); Marina Sharkansky, Haifa (IL); Jarkko L. Kneckt, Los Gatos, CA (US); Leonid Epstein, Netanya (IL); Yong Liu, Campbell, CA (US); Qi Wang, Mountain View, CA (US)

(21) Appl. No.: 19/668,398

(22) Filed: May 5, 2026

Related U.S. Application Data
(60) Provisional application No. 63/800,123, filed on May 5, 2025.

(51) Int. Cl. H04W 72/20

(52) U.S. Cl. CPC H04W 72/20

(57) ABSTRACT

This disclosure relates to methods for a framework for frames when responding to a protected frame in a wireless local area network system. A wireless device receive, from an other wireless device, a protected frame soliciting a response. The wireless device can determine a type, class, and/or format of the protected frame. The wireless device can send, to the other wireless device, a response frame. The response frame can be based, at least in part, on the type, class, and/or format of the protected frame. The protected frame can be a protected control frame, a protected data frame, and/or a protected management frame.

### PRIORITY DATA

This application claims benefit of priority to U.S. Provisional Application Serial No. 63/800,123, titled “Framework for Responding Frames to a Protected Frame”, filed May 5, 2025, which is hereby incorporated by reference in its entirety as though fully and completely set forth herein.

### TECHNICAL FIELD

The present application relates to wireless communication, including techniques and devices for a framework for frames when responding to a protected frame, e.g., such as an IEEE 802.11 based system.

### DESCRIPTION OF THE RELATED ART

Wireless communication systems are ubiquitous. Further, wireless communication technology has evolved from voice-only communications to also include the transmission of data, such as Internet and multimedia content.

Mobile electronic devices, or stations (STAs) or user equipment devices (UEs), can take the form of smart phones or tablets that a user typically carries. One aspect of wireless communication that can commonly be performed by mobile devices can include wireless networking, for example over a wireless local area network (WLAN), which can include devices that operate according to one or more communication standards in the IEEE 802.11 family of standards. In a wireless local area network, it can be possible that certain traffic can be delayed while other communications in the network are being performed. This can potentially cause performance degradation for traffic for which low latency is important, at least in some instances. Accordingly, improvements in the field are desired.

### SUMMARY

Embodiments are presented herein of, inter alia, systems, apparatuses, and methods for a framework for frames when responding to a protected frame (e.g., a protected control frame, a protected management frame, and/or a protected data frame), e.g., such as an IEEE 802.11 based system.

A wireless device can include one or more antennas, one or more radios operably coupled to the one or more antennas, and a processor operably coupled to the one or more radios. The wireless device can be configured to establish a connection with an access point through a wireless local area network (WLAN) over one or multiple wireless links or can be an access point, e.g., a mobile access point, configured to establish a connection with one or more other wireless devices through a WLAN over one or multiple wireless links. In some embodiments, the wireless device can operate in each of the multiple wireless links using a respective radio of the one or more radios.

Similarly, an access point, e.g., a mobile access point, can include one or more antennas, one or more radios operably coupled to the one or more antennas, and a processor operably coupled to the one or more radios. The access point can be configured to establish a connection with one or more wireless devices through a wireless local area network (WLAN) over one or multiple wireless links. In some embodiments, the access point can operate in each of the multiple wireless links using a respective radio of the one or more radios.

For example, in some embodiments, a wireless device can receive, from another wireless device, a protected frame soliciting a response. The wireless device can determine a type, class, and/or format of the protected frame. The wireless device can send, to the other wireless device, a response frame. The response frame can be based, at least in part, on the type, class, and/or format of the protected frame. The protected frame can be a protected control frame, a protected management frame, and/or a protected data frame.

As another example, in some embodiments, a wireless device can transmit, to another wireless device, a protected frame soliciting a response. The wireless device can receive, from the other wireless device, a response frame. The response frame can be based, at least in part, on the type, class, and/or format of the protected frame. The protected frame can be a protected control frame, a protected management frame, and/or a protected data frame.

The techniques described herein can be implemented in and/or used with a number of different types of devices, including but not limited to cellular phones, tablet computers, accessory and/or wearable computing devices, portable media players, base stations, access points, and other network infrastructure equipment, servers, unmanned aerial vehicles, unmanned aerial controllers, automobiles and/or motorized vehicles, and any of various other computing devices.

This summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

A better understanding of the present subject matter can be obtained when the following detailed description of the embodiments is considered in conjunction with the following drawings.

FIG. 1 illustrates an example wireless communication system including a wireless device, according to some embodiments.

FIG. 2 is a block diagram illustrating an example wireless device, according to some embodiments.

FIG. 3 is a block diagram illustrating an example network element or access point, according to some embodiments.

FIG. 4 is a block diagram illustrating an example modem or baseband processor, according to some embodiments.

FIGS. 5A, 5B, and 5C illustrate various frame formats for protected control frames according to IEEE 802.11 specifications.

FIG. 6 illustrates signaling between wireless stations, according to some embodiments.

FIGS. 7 and 8 are flowchart diagrams illustrating methods for responding to a protected frame, according to some embodiments.

While the features described herein are susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

### Terminology

The following are definitions of terms used in this disclosure:

Memory Medium – Any of various types of non-transitory memory devices or storage devices. The term “memory medium” is intended to include any computer system memory or random access memory, such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The term “memory medium” can include two or more memory mediums which can reside in different locations, e.g., in different computer systems that are connected over a network. The memory medium can store program instructions (e.g., embodied as computer programs) that can be executed by one or more processors.

Carrier Medium – a memory medium as described above, as well as a physical transmission medium, such as a bus, network, and/or other physical transmission medium that conveys signals such as electrical, electromagnetic, or digital signals.

Computer System – any of various types of computing or processing systems, including a personal computer system (PC), server-based computer system, wearable computer, network appliance, Internet appliance, smartphone, television system, grid computing system, or other device or combinations of devices. In general, the term "computer system" can be broadly defined to encompass any device (or combination of devices) having at least one processor that executes instructions from a memory medium.

User Equipment (UE) (or “UE Device”) – any of various types of computer systems or devices that are mobile or portable, and that perform wireless communications. Examples of UE devices include mobile telephones or smart phones (e.g., iPhone™, Android™-based phones), tablet computers, portable gaming devices, laptops, wearable devices (e.g., smart watch, smart glasses, smart goggles, head-mounted display devices, and so forth), portable Internet devices, music players, data storage devices, or other handheld devices, automobiles and/or motor vehicles, unmanned aerial vehicles (UAVs) (e.g., drones), UAV controllers (UACs), etc. In general, the term “UE” or “UE device” can be broadly defined to encompass any electronic, computing, and/or telecommunications device (or combination of devices) which is easily transported by a user and capable of wireless communication.

Wireless Device or Station (STA) – any of various types of computer systems or devices that perform wireless communications. A wireless device can be portable (or mobile) or can be stationary or fixed at a certain location. The terms “station” and “STA” are used similarly. A UE is an example of a wireless device.

Communication Device – any of various types of computer systems or devices that perform communications, where the communications can be wired or wireless. A communication device can be portable (or mobile) or can be stationary or fixed at a certain location. A wireless device is an example of a communication device. A UE is another example of a communication device.

Base Station or Access Point (AP) – The term "Base Station" has the full breadth of its ordinary meaning, and at least includes a wireless communication station installed at a fixed location and used to communicate as part of a wireless communication system. The term “access point” (or “AP”) is typically associated with Wi-Fi-based communications and is used similarly.

Processing Element (or Processor) – refers to various elements or combinations of elements that are capable of performing a function in a device, e.g., in a communication device or in a network infrastructure device. Processors can include, for example: processors and associated memory, circuits such as an ASIC (Application Specific Integrated Circuit), portions or circuits of individual processor cores, entire processor cores, processor arrays, programmable hardware devices such as a field programmable gate array (FPGA), and/or larger portions of systems that include multiple processors, as well any of various combinations of the above.

IEEE 802.11 – refers to technology based on IEEE 802.11 wireless standards such as 802.11a, 802.11b, 802.11g, 802.11n, 802.11-2012, 802.11ac, 802.11ad, 802.11ax, 802.11ay, 802.11be, and/or other IEEE 802.11 standards. IEEE 802.11 technology can also be referred to as “Wi-Fi” or “wireless local area network (WLAN)” technology.

Configured to – Various components can be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors can be configured to electrically connect a module to another module, even when the two modules are not connected). In some contexts, “configured to” can be a broad recitation of structure generally meaning “having circuitry that” performs the task or tasks during operation. As such, the component can be configured to perform the task even when the component is not currently on. In general, the circuitry that forms the structure corresponding to “configured to” can include hardware circuits.

Various components can be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

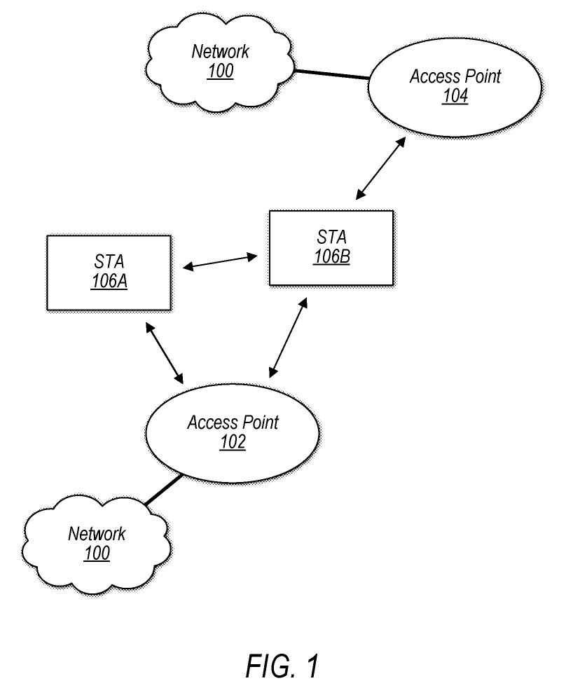

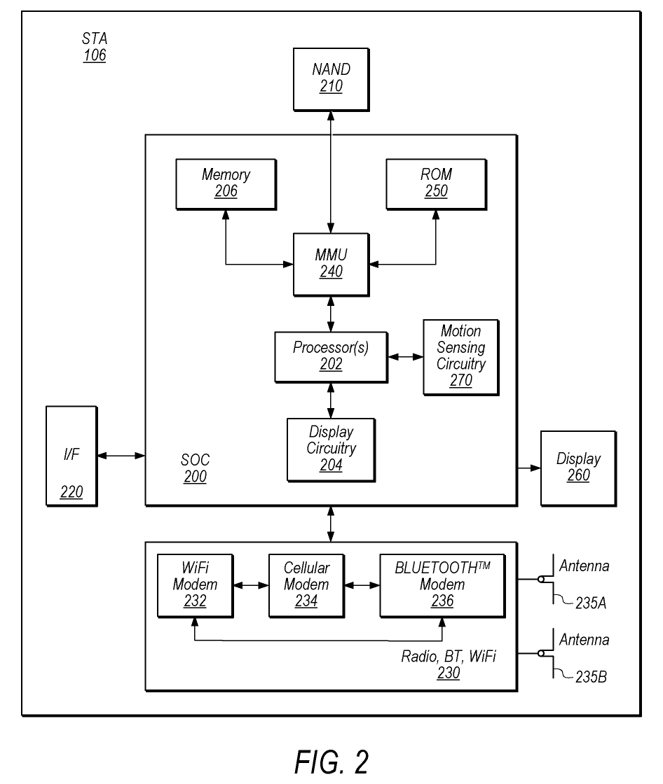

### Figures 1-2 – Wireless Communication System

FIG. 1 illustrates an example of a wireless communication system. It is noted that FIG. 1 represents one possibility among many, and that features of the present disclosure can be implemented in any of various systems, as desired. For example, instances described herein can be implemented in any type of wireless device. The wireless communication system described below is one example.

As shown, the exemplary wireless communication system includes an access point (AP) 102, which communicates over a transmission medium with one or more wireless devices 106A, 106B, etc. Wireless devices 106A and 106B can be user devices, such as stations (STAs), non-AP STAs, UEs, or other WLAN devices.

The STA 106 can be a device with wireless network connectivity, such as a mobile phone, a hand-held device, a wearable device (e.g., such as a smart watch, smart glasses, and/or a head-mounted display device), a computer or a tablet, an unmanned aerial vehicle (UAV), an unmanned aerial controller (UAC), an automobile, or virtually any other type of wireless device. The STA 106 can include a processor (processing element) that is configured to execute program instructions stored in memory. The STA 106 can perform any of the methods described herein by executing one or more of such stored instructions. Alternatively, or in addition, the STA 106 can include a programmable hardware element, such as an FPGA (field-programmable gate array), an integrated circuit (e.g., an ASIC), a programmable logic device (PLD), and/or any of various other possible hardware components that are configured to perform (e.g., individually or in combination) any of the methods described herein, or any portion of any of the methods described herein.

The AP 102 can be a stand-alone AP or an enterprise AP, can be a base transceiver station (BTS) or cell site, and can include hardware that enables wireless communication with the STA devices 106A and 106B. The AP 102 can also be equipped to communicate with a network 100 (e.g., a core network of a service provider (e.g., a cellular service provider, an Internet service provider, and/or a carrier), a WLAN, an enterprise network, and/or another communication network connected to the Internet, among various possibilities). Thus, the AP 102 can facilitate communication among the STA devices 106 and/or between the STA devices 106 and the network 100. AP 102 can be configured to provide communications over one or more wireless technologies, such as any, any combination of, and/or all of 802.11 a, b, g, n, ac, ad, ax, ay, be and/or other 802.11 versions, and/or a cellular protocol, such as 6G, 5G and/or LTE, including in an unlicensed band.

The communication area (or coverage area) of the AP 102 can be referred to as a basic service area (BSA) or cell. The AP 102 and the STAs 106 can be configured to communicate over the transmission medium using any of various radio access technologies (RATs) or wireless communication technologies, such as Wi-Fi, LTE, LTE-Advanced (LTE-A), 5G NR, 6G, ultra-wideband (UWB), etc.

AP 102 and other similar access points (not shown) operating according to one or more wireless communication technologies can thus be provided as a network, which can provide continuous or nearly continuous overlapping service to STA devices 106A-B and similar devices over a geographic area, e.g., via one or more communication technologies. A STA can roam from one AP to another AP directly or can transition between APs and/or network cells (e.g., such as cellular network cells).

Note that at least in some instances a STA device 106 can be capable of communicating using any of multiple wireless communication technologies. For example, a STA device 106 might be configured to communicate using Wi-Fi, LTE, LTE-A, 5G NR, 6G, Bluetooth, UWB, one or more satellite systems, etc. Other combinations of wireless communication technologies (including more than two wireless communication technologies) are also possible. Likewise, in some instances a STA device 106 can be configured to communicate using only a single wireless communication technology.

As shown, the exemplary wireless communication system can also include an access point (AP) 104, which communicates over a transmission medium with the wireless device 106B. The AP 104 also provides communicative connectivity to the network 100. Thus, wireless devices can connect to either or both of AP 102 (or another cellular base station) and the access point 104 (or another access point) to access the network 100. For example, a STA can roam from AP 102 to AP 104, e.g., based on one or more factors, such as mobility, coverage, interference, and/or capabilities. Note that it can also be possible for the AP 104 to provide access to a different network (e.g., an enterprise Wi-Fi network, a home Wi-Fi network, etc.) than the network to which the AP 102 provides access.

The STAs 106A and 106B can include handheld devices such as smart phones or tablets, wearable devices such as smart watches, smart glasses, head-mountable display devices, and/or can include any of various types of devices with wireless communication capability. For example, one or more of the STAs 106A and/or 106B can be a wireless device intended for stationary or nomadic deployment, such as an appliance, measurement device/sensor, control device, etc.

The STA 106B can also be configured to communicate with the STA 106A. For example, the STA 106A and STA 106B can be capable of performing direct device-to-device (D2D) communication. Note that such direct communication between STAs can also or alternatively be referred to as peer-to-peer (P2P) communication. The direct communication can be supported by the AP 102 (e.g., the AP 102 can facilitate discovery, among various possible forms of assistance), or can be performed in a manner unsupported by the AP 102. Such P2P communication can be performed using 3GPP-based D2D communication techniques, Wi-Fi-based P2P communication techniques, UWB, BT, and/or any of various other direct communication techniques, according to various examples.

The STA 106 can include one or more devices or integrated circuits for facilitating wireless communication, potentially including a Wi-Fi modem, cellular modem, and/or one or more other wireless modems. The wireless modem(s) can include one or more processors (processor elements) and various hardware components as described herein. The STA 106 can perform any of (or any portion of) the methods described herein by executing instructions on one or more programmable processors. For example, the STA 106 can be configured to perform techniques according to the various methods described herein. Alternatively, or in addition, the one or more processors can be one or more programmable hardware elements such as an FPGA (field-programmable gate array), application-specific integrated circuit (ASIC), or other circuitry, that is configured to perform any of the methods described herein, or any portion of any of the methods described herein. The wireless modem(s) described herein can be used in a STA device as defined herein, a wireless device as defined herein, or a communication device as defined herein. The wireless modem described herein can also be used in an AP, a base station, a pico cell, a femto cell, and/or other similar network side device.

The STA 106 can include one or more antennas for communicating using two or more wireless communication protocols or radio access technologies (RATs). In some instances, the STA device 106 can be configured to communicate using a single shared radio. The shared radio can couple to a single antenna, or can couple to multiple antennas (e.g., for MIMO) for performing wireless communications. Alternatively, the STA device 106 can include two or more radios, each of which can be configured to communicate via a respective wireless link. Other configurations are also possible.

### Figure 2 – Example Block Diagram of a STA Device

FIG. 2 illustrates an example block diagram of a STA device, such as STA 106. In some instances, the STA 106 can additionally or alternatively be referred to as a UE 106. STA 106 also can be referred to as a non-AP STA 106. As shown, the STA 106 can include a system on chip (SOC) 200, which can include one or more portions configured for various purposes. Some or all of the various illustrated components (and/or other device components not illustrated, e.g., in variations and alternative arrangements) can be “communicatively coupled” or “operatively coupled,” which terms can be taken herein to mean components that can communicate, directly or indirectly, when the device is in operation.

In some instances, the STA 106 can be configured as a Multi-Link Device (MLD). In such instances, the STA 106 (e.g., one or more radios of the STA 106) can be configured for concurrent data transmission and reception in multiple channels across a single band and/or multiple frequency bands (e.g., such as a 2.4 GHz band, a 5 GHz band, and/or a 6 GHz band). As such, the STA 106 (e.g., one or more radios of the STA 106) can be configured to perform Multi-Link Operation (MLO). For example, the STA 106 (e.g., one or more radios of the STA 106) can be configured to perform Simultaneous Transmit Receive (STR) operation (e.g., can be configured for simultaneous uplink and downlink traffic on a pair of links) and/or Enhanced Multi-Link Single-Radio (EMLSR) operation (e.g., can be configured such that a single-radio is used to listen to two or more links simultaneously).

As shown, the SOC 200 can include processor(s) 202, which can execute program instructions for the STA 106, and display circuitry 204, which can perform graphics processing and provide display signals to the display 260. The SOC 200 can also include motion sensing circuitry 270, which can detect motion of the STA 106 in one or more dimensions, for example using a gyroscope, accelerometer, and/or any of various other motion sensing components. The processor(s) 202 can also be coupled to memory management unit (MMU) 240, which can be configured to receive addresses from the processor(s) 202 and translate those addresses to locations in memory (e.g., memory 206, read only memory (ROM) 250, flash memory 210). The MMU 240 can be configured to perform memory protection and page table translation or set up. In some instances, the MMU 240 can be included as a portion of the processor(s) 202.

As shown, the SOC 200 can be coupled to various other circuits of the STA 106. For example, the STA 106 can include various types of memory (e.g., including NAND flash 210), a connector interface 220 (e.g., for coupling to a computer system, dock, charging station, etc.), the display 260, and wireless communication circuitry 230 (e.g., for LTE, LTE-A, 5G NR, 6G, Bluetooth, Wi-Fi, NFC, GPS, UWB, peer-to-peer (P2P), device-to-device (D2D), etc.).

The STA 106 can include at least one antenna, and in some instances can include multiple antennas, e.g., 235A and 235B, for performing wireless communication with access points, base stations, wireless stations, and/or other devices. For example, the STA 106 can use antennas 235A and 235B to perform the wireless communication. As noted above, the STA 106 can, in some examples, be configured to communicate wirelessly using a plurality of wireless communication standards or radio access technologies (RATs).

The wireless communication circuitry 230 can include a Wi-Fi modem 232, a cellular modem 234, and a Bluetooth modem 236. Note that one or more of the Wi-Fi modem 232, the cellular modem 234, and/or the Bluetooth modem 236 can be configured for MLO, e.g., as described above. The Wi-Fi modem 232 is for enabling the STA 106 to perform Wi-Fi or other WLAN communications, e.g., on an 802.11 network. The Bluetooth modem 236 is for enabling the STA 106 to perform Bluetooth communications. The cellular modem 234 can be capable of performing cellular communication according to one or more cellular communication technologies, e.g., in accordance with one or more 3GPP specifications.

As described herein, STA 106 can include hardware and software components for implementing aspects of this disclosure. For example, one or more components of the wireless communication circuitry 230 (e.g., Wi-Fi modem 232, cellular modem 234, BT modem 236) of the STA 106 can be configured to implement part or all of the methods for a framework for frames when responding to a protected frame in a wireless local area network system described herein, e.g., by a processor executing program instructions stored on a memory medium (e.g., a non-transitory computer-readable memory medium), a processor configured as an FPGA (Field Programmable Gate Array), and/or using dedicated hardware components, which can include an ASIC (Application Specific Integrated Circuit).

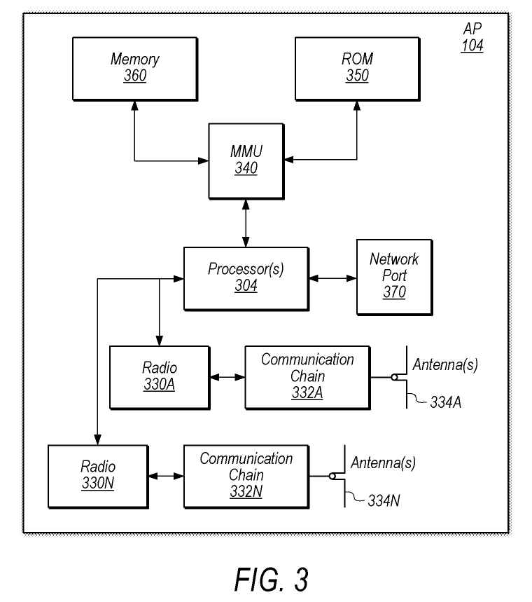

### Figure 3 – Block Diagram of an Access Point

FIG. 3 illustrates an example block diagram of an access point (AP) 104. In some instances (e.g., in an 802.11 communication context), the AP 104 can also be referred to as a station (STA), a mobile AP, and possibly more particularly as an AP STA. It is noted that the AP of FIG. 3 is merely one example of a possible access point. As shown, AP 104 can include processor(s) 304, which can execute program instructions for the AP 104. The processor(s) 304 can also be coupled to memory management unit (MMU) 340, which can be configured to receive addresses from the processor(s) 304 and translate those addresses to locations in memory (e.g., memory 360 and read only memory (ROM) 350) or to other circuits or devices.

In some instances, the AP 104 can be configured as a Multi-Link Device (MLD). In such instances, the AP 104 (e.g., one or more radios of the AP 104) can be configured for concurrent data transmission and reception in multiple channels across a single band and/or multiple frequency bands (e.g., such as a 2.4 GHz band, a 5 GHz band, and/or a 6 GHz band). As such, the AP 104 (e.g., one or more radios of the AP 104) can be configured to perform Multi-Link Operation (MLO). For example, the AP 104 (e.g., one or more radios of the AP 104) can be configured to perform Simultaneous Transmit Receive (STR) operation (e.g., can be configured for simultaneous uplink and downlink traffic on a pair of links) and/or Enhanced Multi-Link Single-Radio (EMLSR) operation (e.g., can be configured such that a single-radio is used to listen to two or more links simultaneously).

The AP 104 can include at least one network port 370. The network port 370 can be configured to couple to a network and provide multiple devices, such as STA devices 106, with access to the network, for example as described herein above in FIG. 1.

The network port 370 (or an additional network port) can also or alternatively be configured to couple to a cellular network, e.g., a core network of a cellular service provider (e.g., a carrier and/or cellular carrier). The core network can provide mobility related services and/or other services to a plurality of devices, such as STA devices 106. In some cases, the network port 370 can couple to a telephone network via the core network, and/or the core network can provide a telephone network (e.g., among other STA devices serviced by the cellular service provider).

The AP 104 can include one or more radios 330A-330N, which can be coupled to one or more respective communication chains and at least one antenna 334, and possibly multiple antennas. The antenna(s) 334 can be configured to operate, in conjunction with one or more other components, as a wireless transceiver and can be further configured to communicate with STA devices 106 via radios 330A-330N. Note that one or more of the radios 330A-330N can be configured for MLO, e.g., as described above. The antenna(s) 334A-N communicate with one or more respective radios 330A-N via communication chains 332A-N. Communication chains 332 can be receive chains, transmit chains, or both. The radios 330A-N can be configured to communicate in accordance with various wireless communication standards, including, but not limited to, LTE, LTE-A, 5G NR, 6G, UWB, Wi-Fi, BT, etc. The AP 104 can be configured to operate on multiple wireless links using the one or more radios 330A-N. In some implementations, each radio can be used to operate on a respective wireless link.

The AP 104 can be configured to communicate wirelessly using multiple wireless communication standards. In some instances, the AP 104 can include multiple radios, which can enable the network entity to communicate according to multiple wireless communication technologies. For example, as one possibility, the AP 104 can include a 4G or 5G radio for performing communication according to a 3GPP wireless communication technology, as well as a Wi-Fi radio for performing communication according to one or more Wi-Fi specifications. In such a case, the AP 104 can be capable of operating as both a cellular base station and a Wi-Fi access point. As another possibility, the AP 104 can include a multi-mode radio that is capable of performing communications according to any of multiple wireless communication technologies (e.g., 5G NR and Wi-Fi, 5G NR and LTE, etc.). As still another possibility, the AP 104 can be configured to act exclusively as a Wi-Fi access point, e.g., without cellular communication capability.

As described further herein, the AP 104 can include hardware and software components for implementing or supporting implementation of features described herein, among various other possible features. The processor 304 of the AP 104 can be configured to implement, or support implementation of, part or all of the methods described herein, e.g., by executing program instructions stored on a memory medium (e.g., a non-transitory computer-readable memory medium) to operate multiple wireless links using multiple respective radios. Alternatively, the processor 304 can be configured as a programmable hardware element, such as an FPGA (Field Programmable Gate Array) or ASIC (Application Specific Integrated Circuit), or a combination thereof. Alternatively (or in addition) the processor 304 of the AP 104, in conjunction with one or more of the other components 330, 332, 334, 340, 350, 360, 370 can be configured to implement, or support implementation of, part or all of the features described herein.

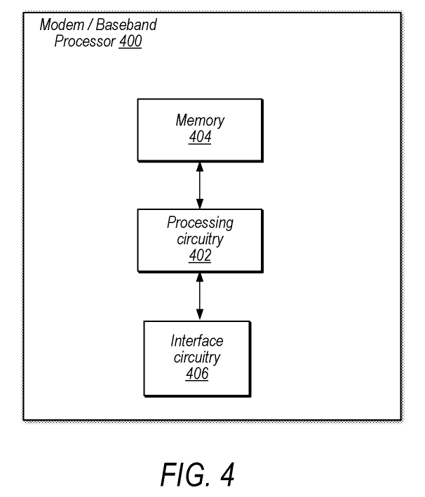

### Figure 4 – Block Diagram of a Modem or Baseband Processor

FIG. 4 illustrates an example block diagram of a modem 400, which can also be referred to as baseband processor 400. The modem 400 can provide signal processing functionality for one or more wireless communication technologies, such as Wi-Fi, Bluetooth, and/or a cellular (e.g., 3GPP) communication technology. Thus, as one possibility, modem 400 can represent a Wi-Fi modem; for example, the modem 400 illustrated in FIG. 4 can represent one possible example of Wi-Fi modem 232 illustrated in FIG. 2. As another possibility, modem 400 can represent a cellular modem or cellular baseband processor; for example, the modem 400 illustrated in FIG. 4 can represent one possible example of cellular modem 234 illustrated in FIG. 2. As a still further possibility, modem 400 can represent a Bluetooth modem; for example, the modem 400 illustrated in FIG. 4 can represent one possible example of Wi-Fi modem 236 illustrated in FIG. 2. As a yet further possibility, modem 400 can represent a radio; for example, the modem 400 illustrated in FIG. 4 can represent one possible example of radio 330A or radio 330N illustrated in FIG. 3. In some instances, the modem 400 could implement functionality for supporting communication according to multiple wireless communication technologies. At least in some instances, the modem 400 can run a real-time operating system, e.g., for facilitating performance of timing-dependent wireless communication functionality.

In some instances, the modem 400 can be configured for concurrent data transmission and reception in multiple channels across a single band and/or multiple frequency bands (e.g., such as a 2.4 GHz band, a 5 GHz band, and/or a 6 GHz band). As such, the modem 400 can be configured to perform Multi-Link Operation (MLO). For example, the modem 400 can be configured to perform Simultaneous Transmit Receive (STR) operation (e.g., can be configured for simultaneous uplink and downlink traffic on a pair of links) and/or Enhanced Multi-Link Single-Radio (EMLSR) operation (e.g., can be configured such that a single-radio is used to listen to two or more links simultaneously).

The modem 400 can include processing circuitry 402, which could include one or more processor cores, ASICs, programmable hardware elements, digital signal processors, and/or other processing elements. The processing circuitry can be capable of preparing baseband signals for up-conversion and transmission by radio circuitry of a wireless device, and/or for processing baseband signals received and down-converted by radio circuitry of a wireless device. Such processing could include signal modulation, encoding, decoding, etc., among various possible functions. The processing circuitry can also or alternatively be capable of performing functionality for one or more baseband and/or other layers/sublayers of a protocol stack for the wireless communication technology (or technologies) implemented by the modem 400, such as physical layer (PHY) functionality, media access control (MAC) functionality, logical link control (LLC) functionality, radio resource control (RRC) functionality, radio link control (RLC) functionality, etc. In some instances, the modem 400 can itself include at least some radio circuitry (e.g., for performing the conversion of input baseband signals to radio frequency signals and/or of input radio frequency signals to baseband signals). Alternatively, or in addition, some or all such functions can be performed by separate radio/transceiver components of the wireless device.

The modem 400 can also include memory 404, which can include a non-transitory computer-readable memory medium. The memory 404 can include program instructions for performing signal processing and/or any of various possible general processing functions. The processing circuitry 402 can be capable of executing the program instructions stored in the memory 404. The memory 404 can also store data generated and/or used during processing performed by the processing circuitry 402.

As shown, the modem 400 can further include interface circuitry, e.g., for communicating with other components of a wireless device (such as STA 106 or AP 104 illustrated in FIGS. 1-3), such as an application processor, radio / transceiver circuitry, and/or any of various other components. Such interfaces can be implemented in any of various ways; for example, as one possibility, the modem 400 can have a direct interface with transceiver circuitry of a wireless device and can have an additional indirect interface with an application processor and/or other components of the wireless device by way of a system bus. Other configurations are also possible.

In at least some instances, the hardware and software components of the modem 400 can be configured to implement or support implementation of features described herein, among various other possible features. For example, the processing circuitry 402 of the modem 400 can be configured to implement, or support implementation of, part or all of the methods described herein, e.g., by executing program instructions stored on memory (e.g., non-transitory computer-readable memory medium) 404 and/or using dedicated hardware components.

### Framework for Frames When Responding to a Protected Frame

In current implementations, IEEE has introduced control frame protection to enhance security in a Wi-Fi (e.g., an IEEE 802.11) network. However, IEEE has not defined a framework (e.g., rules) for responding frames, e.g., a frame sent in response to receiving a soliciting physical layer protocol data unit (PPDU) containing a protected control frame, a protected data frame, and/or a protected management frame. For example, IEEE has not defined what type of responding frame can be sent when a particular soliciting frame has been received, e.g., such as when control frame protection is enabled between two wireless devices. A soliciting frame can be, among other frames, a protected data frame, a protected management frame, a protected compressed block acknowledgement request (BAR) frame, a protected multiple traffic identifier (multi-TID) BAR frame, a protected multi-user BAR (MU-BAR) trigger frame, a protected Group Cast with Retries (GCR) (MU-BAR) trigger frame, a protected buffer status report poll (BSRP) trigger frame, a protected bandwidth query report poll (BQRP) trigger frame, a protected basic trigger frame, a protected beamforming report poll (BFRP) trigger frame, a protected Neighbor Discovery Protocol (NDP) feedback request poll (NFRP) frame, a protected Ranging Trigger frame such as a Poll Ranging Trigger frame variant, various protected frames aggregated with other medium access control (MAC) protocol data units (MPDUs), various protected frames aggregated with other PPDUs, and various protected frames associated with ranging. Therefore, improvements are desired.

Embodiments described herein provide methods and mechanisms for a framework for frames when responding to a protected frame, e.g., such as a protected control frame, a protected data frame, and/or a protected management frame, on a wireless device supporting a protected control frame feature of an IEEE 802.11 protocol. In particular, embodiments described herein provide methods and mechanisms for rules for responding frames to a soliciting physical layer protocol data unit (PPDU) that includes a protected frame (e.g., a protected control frame, a protected data frame, and/or a protected management frame, e.g., such as in an IEEE 802.11 network. For example, in instances in which control frame protection (CFP) is enabled and a wireless station receives a soliciting PPDU that contains a protected control frame, a protected data frame or a protected management frame, the wireless station can apply rules presented herein to determine whether or not a response frame needs to be protected. In other words, in instances in which CFP is enabled and a wireless station receives a protected frame, the wireless station can apply the rules presented herein to determine a format of a responding frame, e.g., whether or not the responding frame requires protection. Said another way, when a wireless station receives a protected frame, the wireless station can apply the rules presented herein to determine whether or not the responding frame requires protection.

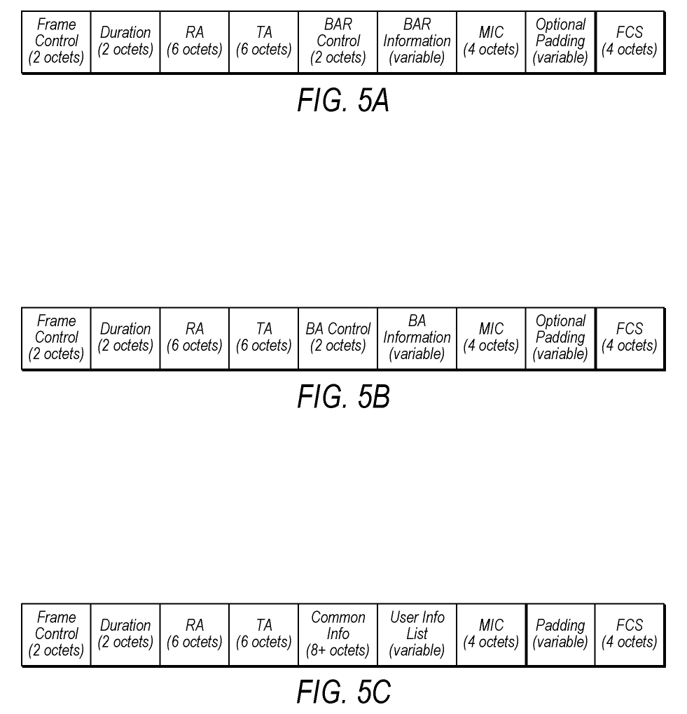

Note that as described herein, a protected frame comprises a frame that includes an integrity check. For example, a frame previously defined in IEEE 802.11 specifications, e.g., such as a block ack request (BAR) frame, a multi-user block acknowledgement (M-BA) frame, and/or a protected trigger frame illustrated can be enhanced and/or modified to include a message integrity code (MIC) field, e.g., to add security protection to the frame previously defined in IEEE 802.11 as illustrated in FIGS. 5A (protected BAR frame format), FIG. 5B (protected M-BA frame format), and FIG. 5C (protected trigger frame format). The MIC field can be decoded by a receiving device via a shared secret or shared key. Such a field can be used to verify that transmitted data (e.g., data received at the device) has not been tampered with or corrupted during transit. In particular, a MIC can be a cryptographic code calculated by both a transmitting device and a receiving device based on a data frame and a secret key. Further, when MIC values match, it indicates that the data is authentic and has not been altered.

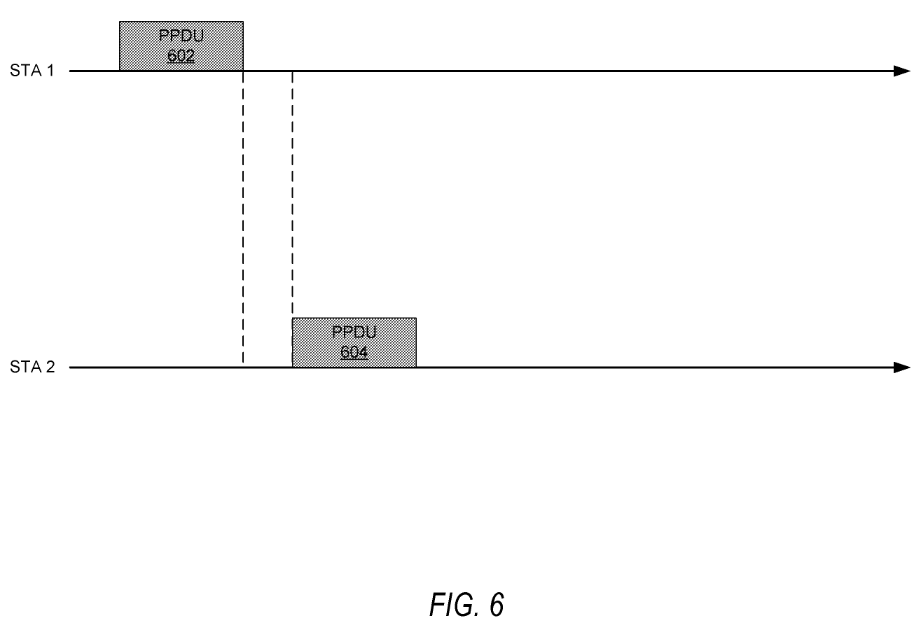

FIG. 6 illustrates signaling between wireless stations, according to some embodiments. As shown, a wireless station (e.g., STA 2), such as wireless station 106, can receive, from another wireless station (e.g., a soliciting wireless station, such as STA 1), such as another wireless station 106 and/or an AP 104, a protected frame, (e.g., a protected control frame, a protected data frame, and/or a protected management frame) in PPDU 602 that is soliciting a response from the wireless station. The wireless station can determine a type of the protected frame and then send a response frame in PPDU 604, e.g., based, at least in part, on the type of the protected frame. In other words, the wireless station can determine a type of the response frame based on the type of the protected frame, e.g., according to one or more rules as described herein.

For example, in some instances, when the protected frame soliciting a response (e.g., a soliciting frame) is any of a protected data frame, a protected management frame, a protected compressed BAR frame, a protected multi-TID BAR frame, a protected GCR MU-BAR trigger frame, and/or a protected MU-BAR trigger frame, the wireless station can respond with a protected multi-user block acknowledgement (M-BA) frame. In some instances, when the protected frame soliciting a response (e.g., a soliciting frame) is any of a protected data frame, a protected management frame, a protected compressed BAR frame, a protected multi-TID BAR frame, a protected GCR MU-BAR trigger frame, and/or a protected MU-BAR trigger frame, the wireless station can respond with a protected M-BA frame, e.g., even when a soliciting frame is carried in a single medium access control (MAC) protocol data unit (S-MPDU). Note that for a protected frame received before a block acknowledgement session has been enabled, if the protected frame solicits an acknowledgement, the wireless station can respond with a protected M-BA frame (e.g., a variant of M-BA frame that does not contain a block acknowledgement bitmap subfield) or respond with an acknowledgement frame. In instances in which the wireless station responds with the acknowledgement frame, the wireless station can additionally coordinate with a transmitter of the protected frame to set up a block acknowledgement (BA) session. Note further that once a BA session has been established and CFP has been enabled, usage of an acknowledgement frame can be disallowed (e.g., and replaced with a protected M-BA frame), at least in some instances. In other instances, usage of an acknowledgement frame and a protected M-BA frame can both be allowed after a BA session has been established and CFP has been enabled.

Note that when the protected frame soliciting a response (e.g., a soliciting frame) is a protected M-BA frame aggregated with other MPDUs, the wireless station can respond with a protected M-BA frame and/or a protected M-BA frame aggregated with one or more data frames.

As another example, when the protected frame soliciting a response (e.g., a soliciting frame) is a protected BSRP trigger frame and/or a protected BSRP trigger frame aggregated with other MPDUs, the wireless station can respond with a protected M-BA frame, a protected M-BA frame aggregated with a QoS null frame, or a QoS null frame. Note that the BSRP trigger frame can solicit buffer status report (BSR) information and/or unavailability information. In some instances, e.g., such as when responding with a protected M-BA frame, the protected M-BA frame can include an embedded BSR and queue size information. Further, BSR information, e.g., the embedded BSR, can include enhanced BSR information in an A-Control field and/or in a QoS Info Field of the M-BA frame. In addition, the protected M-BA frame can include other A-Control field information as well, such as a bandwidth query report (BQR) or an upstream power headroom (UPH). In some instances, e.g., such as when responding with a protected M-BA frame aggregated with a QoS null frame, if the other wireless station (e.g., the soliciting wireless station) only receives the QoS null frame from the wireless station (e.g., the protected M-BA frame is not decoded successfully from the wireless station, e.g., due to transmission errors and/or MIC verification errors), transmissions to the wireless station can be aborted for a current transmission opportunity. In addition, the wireless station can be required to place the protected M-BA frame at a beginning of an aggregate MPDU (AMPDU), e.g., to minimize risk of non-receipt of the protected M-BA frame. In other instances, if the other wireless station (e.g., the soliciting wireless station) only receives one of the QoS null frame or protected M-BA frame, transmissions to the wireless station can continue. In other words, as long as a frame is received from the wireless station, transmissions to the wireless station can continue in a current transmit opportunity. In some instances, e.g., such as when responding with a QoS null frame, a BSR can be included in the QoS null frame. In such instances, the BSR can be protected if the QoS null frame is aggregated with a data frame or management frame with a no-acknowledgement option.

As a further example, when the protected frame soliciting a response (e.g., a soliciting frame) is a protected BQRP trigger frame and/or a protected BQRP trigger frame aggregated with other MPDUs, the wireless station can respond with a protected M-BA frame. In some instances, the protected M-BA frame can include an embedded BQR. Further, BQR information, e.g., the embedded BQR, can include enhanced BQR information in an A-Control field and/or in a QoS Info Field of the M-BA frame. In addition, the protected M-BA frame can include other A-Control field information as well, such as a BSR or an upstream power headroom (UPH). In some instances, e.g., such as when responding with a protected M-BA frame aggregated with a QoS null frame, if the other wireless station (e.g., the soliciting wireless station) only receives the QoS null frame from the wireless station (e.g., the protected M-BA frame is not decoded successfully from the wireless station, e.g., due to transmission errors and/or MIC verification errors), transmissions to the wireless station can be aborted for a current transmission opportunity. In addition, the wireless station can be required to place the protected M-BA frame at a beginning of an aggregate MPDU (AMPDU), e.g., to minimize risk of non-receipt of the protected M-BA frame. In other instances, if the other wireless station (e.g., the soliciting wireless station) only receives one of the QoS null frame or protected M-BA frame, transmissions to the wireless station can continue. In other words, as long as a frame is received from the wireless station, transmissions to the wireless station can continue in a current transmit opportunity. In some instances, e.g., such as when responding with a QoS null frame, a BQR can be included in the QoS null frame. In such instances, the BQR can be protected if the QoS null frame is aggregated with a data frame or management frame with a no-acknowledgement option.

Note that when the protected frame soliciting a response (e.g., a soliciting frame) is a protected NFRP trigger and/or a protected NFRP frame aggregated with other MPDUs, the wireless station can respond as currently defined in 802.11 specifications.

As yet another example, when the protected frame soliciting a response (e.g., a soliciting frame) is a protected basic trigger frame, the wireless station can respond with a protected data frame, a protected management frame, and/or a protected M-BA frame aggregated with protected data. Additionally, when the protected frame soliciting a response (e.g., a soliciting frame) is a protected basic trigger frame aggregated with other MPDUs, the wireless station can respond with a protected M-BA frame, a protected M-BA frame aggregated together with a data frame, and/or a protected M-BA frame aggregated together with a management frame.

As a yet further example, when the protected frame soliciting a response (e.g., a soliciting frame) is a protected BFRP trigger frame, the wireless station can respond with an unprotected BFR frame (e.g., since an attacker cannot cause much harm via a fake BFR), a protected BFR, and/or a protected M-BA frame aggregated with an unprotected BFR frame.

As an additional example, when the protected frame soliciting a response (e.g., a soliciting frame) is a protected ranging poll trigger frame, the wireless station can respond with a clear-to-send to self (CTS-2-Self) frame, a protected M-BA frame, or a protected CTS-2-Self frame. Note that when a protected M-BA is used, e.g., instead of a CTS-2-Self frame, the protected ranging poll trigger frame can be required to allocate a sufficient amount of time for a trigger based (TB) PPDU to accommodate the protected M-BA which is a larger frame than the CTS-2-Self frame. Note that a protected CTS-2-Self frame can be a CTS-2-Self frame that is expanded to include a packet number (PN) and/or MIC field in a TB PPDU. Note that when a protected CTS-2-Self frame is used, e.g., instead of a CTS-2-Self frame, the protected ranging poll trigger frame can be required to allocate a sufficient amount of time for a TB PPDU to accommodate the protected CTS-2-Self which is a larger frame than the CTS-2-Self frame.

As a yet additional example, when the protected frame soliciting a response (e.g., a soliciting frame) is a protected ranging poll trigger frame that solicits response from an unassociated station based on a ranging session identifier (RSID) assigned to a wireless station, the wireless station can respond with a clear-to-send to self (CTS-2-Self) frame, a protected M-BA frame, or a protected CTS-2-Self frame. Note that when a protected M-BA is used, e.g., instead of a CTS-2-Self frame, the protected ranging poll trigger frame can be required to allocate a sufficient amount of time for a trigger based (TB) PPDU to accommodate the protected M-BA which is a larger frame than the CTS-2-Self frame. Note that a protected CTS-2-Self frame can be a CTS-2-Self frame that is expanded to include a packet number (PN) and/or MIC field in a TB PPDU. Note that when a protected CTS-2-Self frame is used, e.g., instead of a CTS-2-Self frame, the protected ranging poll trigger frame can be required to allocate a sufficient amount of time for a TB PPDU to accommodate the protected CTS-2-Self which is a larger frame than the CTS-2-Self frame.

As a yet further additional example, when the protected frame soliciting a response (e.g., a soliciting frame) is a protected ranging trigger frame, the wireless station can respond as currently defined in current IEEE 802.11 specifications. For example, when the protected ranging trigger frame triggers secure sounding, the wireless station can respond via a secure ranging procedure previously defined to protect a ranging null data packet (NDP) frame. As another example, when the protected ranging trigger frame triggers reporting, the wireless station can respond via a secure ranging procedure previously defined to protect a location measurement report (LMR) frame. As an additional example, when the protected ranging trigger frame triggers passive sounding, the wireless station can respond via a ranging procedure previously defined for passive sounding, e.g., with a ranging NDP frame. Note that for non-trigger-based ranging procedures, the wireless station can send NDPA (null data packet announcement) frames and NDP frames associated with the non-trigger-based ranging procedures as defined in current IEEE 802.11 specifications as these existing non-trigger-based ranging procedures protect these frames.

In some instances, when control frame protection is enabled between wireless devices, e.g., STA1 and STA2, a transmitting device (e.g., STA 1), can be restricted from transmitting unprotected frames, e.g., such as a request-to-send (RTS) frame, a multi-user RTS (MU-RTS) frame, and/or a sounding ranging trigger frame to a receiving device in PPDU 602 (e.g., STA 2). As an example, instead of transmitting an RTS frame or a MU-RTS frame (e.g., such as for network allocation vector (NAV) protection or for transmit opportunity sharing), the transmitting device can transmit a protected BSRP frame. The protected BSRP frame can include, among other information, information needed for transmit opportunity sharing, such as a duration and a sharing mode of a shared transmit opportunity, e.g., similar to fields defined in an MU-RTS triggered transmission opportunity sharing (TXS) frame. As another example, instead of transmitting a sounding ranging trigger from, the transmitting device can enable secure ranging with the receiving device and then transmit a secure sounding ranging trigger frame.

Similarly, in some instances, when control frame protection is enabled between wireless devices, e.g., STA1 and STA2, a receiving device (e.g., STA 2) can be restricted from transmitting unprotected frames, e.g., such as an RTS frame, e.g., in PPDU 604. As an example, for NAV protection, the receiving device can transmit a protected BSRP frame to the transmitting device. As another example, to initiate a transmit opportunity with the transmitting device (e.g., such as when the transmitting device is an AP in dynamic power save mode), the receiving device can transmit a protected BSRP frame to the transmitting device.

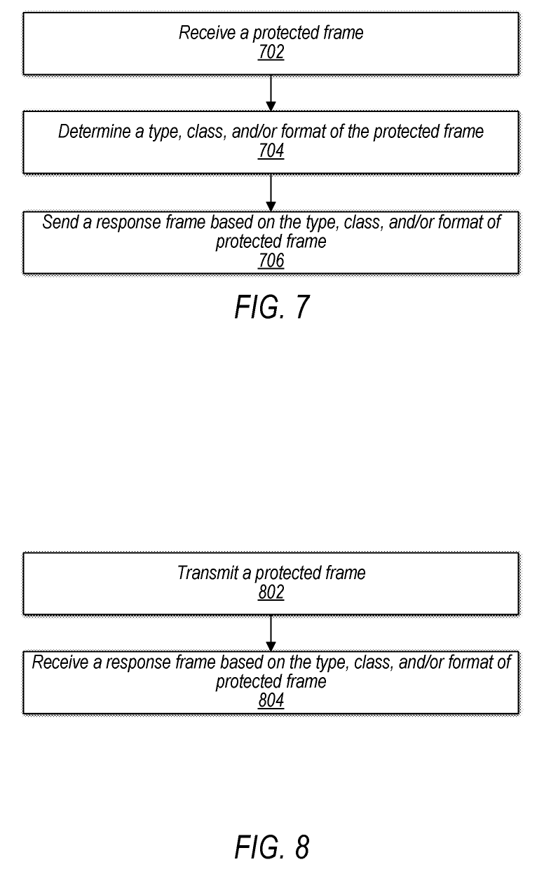

FIGS. 7 and 8 are a flowchart diagrams illustrating methods for responding to a protected frame, according to some embodiments. In various embodiments, some of the elements of the methods shown can be performed concurrently, in a different order than shown, can be substituted for by one or more other method elements, or can be omitted. Additional method elements can also be performed as desired.

Aspects of the methods of FIGS. 7 and 8 can be implemented by a wireless device, such as the AP 104 or STA 106 illustrated in and described with respect to FIGS. 1-4, or more generally in conjunction with any of the computer circuitry, systems, devices, elements, or components shown in the Figures, among others, as desired. For example, a processor (such as baseband processor 400 illustrated in and described with respect to FIG. 4) and/or other hardware of such a device can be configured to cause the device to perform any combination of the illustrated method elements and/or other method elements.

Note that while at least some elements of the methods of FIGS. 7 and 8 are described in a manner relating to the use of communication techniques and/or features associated with IEEE 802.11 specification documents, such description is not intended to be limiting to the disclosure, and aspects of the methods of FIGS. 7 and 8 can be used in any suitable wireless communication system, as desired. Turning to FIG. 7, as shown, this method can operate as follows.

At 702, a wireless station (e.g., such as wireless station 106) can receive, from an other wireless station, a protected frame (e.g., a protected data frame, a protected management frame, and/or a protected control frame) soliciting a response from the wireless station. The other wireless station can be an access point, such as AP 104, or a wireless station, such as wireless station 106. The protected frame can include a message integrity code (MIC) field. The protected frame can be received in a physical protocol data unit (PPDU). In addition, the protected frame can be aggregated with other frames in the PPDU.

At 704, the wireless station can determine a type, class, and/or format of the protected frame. For example, the wireless station can determine whether the protected frame is a protected data frame, a protected management frame, a protected compressed block acknowledgement request (BAR) frame, a protected multiple traffic identifier (multi-TID) BAR frame, a protected multi-user BAR (MU-BAR) trigger frame, a protected Group Cast with Retries (GCR) (MU-BAR) trigger frame, a protected buffer status report poll (BSRP) trigger frame, a protected bandwidth query report poll (BQRP) trigger frame, a protected basic trigger frame, a protected beamforming report poll (BFRP) trigger frame, a protected Neighbor Discovery Protocol (NDP) feedback request poll (NFRP) frame, various protected frames aggregated with other medium access control (MAC) protocol data units (MPDUs), various protected frames aggregated with other PPDUs, and/or various protected frames associated with ranging.

At 706, the wireless station can send, to the other wireless station, a response frame based, at least in part, on the type, class, and/or format of the protected frame. In some instances, when the response frame is a protected frame, the response frame can include a MIC field.

In some instances, when the wireless station determines that the type, class, and/or format of protected frame is any of a protected data frame, a protected management frame, a protected compressed BAR frame, a protected multi-TID BAR frame, a protected GCR MU-BAR trigger frame, and/or a protected MU-BAR trigger frame, the response frame can be a protected multi-user block acknowledgement (M-BA) frame (e.g., an M-BA frame enhanced/modified to include a MIC field).

In some instances, when the wireless station determines that the type, class, and/or format of protected frame is any of a protected data frame, a protected management frame, a protected compressed BAR frame, a protected multi-TID BAR frame, a protected GCR MU-BAR trigger frame, and/or a protected MU-BAR trigger frame, the wireless station can further determine whether a block acknowledgement (blockack) session has been enabled. Further, when the wireless station determines that a blockack session has not been enabled, the response frame can be an M-BA enablement frame. Additionally, when the wireless station determines that a blockack session has been enabled, the response frame can be a protected M-BA frame.

In some instances, when the wireless station determines that the type, class, and/or format of the protected frame is a protected BSRP trigger frame and/or a protected BSRP trigger frame aggregated with other MPDUs, the response frame can be a protected M-BA frame, a protected M-BA frame aggregated with a Quality of Service (QoS) null frame, and/or a QoS null frame. Note that the BSRP trigger frame can solicit buffer status report (BSR) information and/or unavailability information. In some instances, such as when the response frame is a protected M-BA frame, the wireless station can embed the BSR into the protected M-BA frame. Further, BSR information, e.g., the embedded BSR, can include enhanced BSR information in an A-Control field and/or in a QoS Info Field of the M-BA frame. In addition, the protected M-BA frame can include other A-Control field information as well, such as a bandwidth query report (BQR) or an upstream power headroom (UPH). In some instances, such as when the response frame is a protected M-BA frame aggregated with a QoS null frame, if the other wireless station only receives the QoS null frame from the wireless station (e.g., the protected M-BA frame is not decoded successfully from the wireless station, e.g., due to transmission errors and/or MIC verification errors), transmissions to the wireless station can be aborted for a current transmission opportunity. In addition, the wireless station can be required to place the protected M-BA frame at a beginning of an aggregate MPDU (AMPDU), e.g., to minimize risk of non-receipt of the protected M-BA frame. In other instances, if the other wireless station (e.g., the soliciting wireless station) only receives one of the QoS null frame or protected M-BA frame, transmissions to the wireless station can continue. In other words, as long as a frame is received from the wireless station, transmissions to the wireless station can continue in a current transmit opportunity. In some instances, such as when the response frame is a QoS null frame, the wireless station can include the BSR in the QoS null frame. In such instances, the BSR can be protected if the QoS null frame is aggregated with a data frame or management frame with a no-acknowledgement option.

In some instances, when the wireless station determines that the type, class, and/or format of the protected control frame is a protected BQRP trigger frame and/or a protected BQRP trigger frame aggregated with other MPDUs, the response frame can be a protected M-BA frame. In some instances, the protected M-BA frame can include an embedded BQR. Further, BQR information, e.g., the embedded BQR, can include enhanced BQR information in an A-Control field and/or in a QoS Info Field of the M-BA frame. In addition, the protected M-BA frame can include other A-Control field information as well, such as a BSR or an upstream power headroom (UPH). In some instances, such as when the response frame is a protected M-BA frame aggregated with a QoS null frame, if the other wireless station only receives the QoS null frame from the wireless station (e.g., the protected M-BA frame is not decoded successfully from the wireless station, e.g., due to transmission errors and/or MIC verification errors), transmissions to the wireless station can be aborted for a current transmission opportunity. In addition, the wireless station can be required to place the protected M-BA frame at a beginning of an aggregate MPDU (AMPDU), e.g., to minimize risk of non-receipt of the protected M-BA frame. In other instances, if the other wireless station (e.g., the soliciting wireless station) only receives one of the QoS null frame or protected M-BA frame, transmissions to the wireless station can continue. In other words, as long as a frame is received from the wireless station, transmissions to the wireless station can continue in a current transmit opportunity. In some instances, such as when the response frame is a QoS null frame, the wireless station can include the BQR in the QoS null frame. In such instances, the BQR can be protected if the QoS null frame is aggregated with a data frame or management frame with a no-acknowledgement option. In some instances, if a receiver addressed by the response frame fails to decode the protected M-BA frame while succeeding in decoding the QoS null frame, the receiver can treat the response frame as a failure by discarding the QoS null frame, not trusting any information in the QoS null frame, and/or aborting a current transmit opportunity or treat the response frame as a success by continuing to decode the QoS null frame or transmitting a subsequent frame in the transmit opportunity based on the response frame.

In some instances, when the wireless station determines that the type, class, and/or format of the protected frame is a protected NFRP trigger and/or a protected NFRP frame aggregated with other MPDUs, the response frame can be a frame as currently defined in 802.11 specifications.

In some instances, when the wireless station determines that the type, class, and/or format of the protected frame is a protected basic trigger frame, the response frame can be at least a protected data frame, at least a protected management frame, and/or a protected M-BA frame aggregated with at least a protected data frame or a protected management frame. Additionally, In some instances, when the wireless station determines that the type, class, and/or format of the protected control frame is a protected basic trigger frame aggregated with other MPDUs, the response frame can be a protected M-BA frame, a protected M-BA frame aggregated together with a data frame, and/or a protected M-BA frame aggregated together with a management frame.

In some instances, when the wireless station determines that the type, class, and/or format of the protected frame is a protected BFRP trigger frame, the response frame can be an unprotected BFR frame (e.g., since an attacker cannot cause much harm via a fake BFR), a protected BFR, and/or a protected M-BA frame aggregated with an unprotected BFR frame.

In some instances, when the wireless station determines that the type, class, and/or format of the protected frame is a protected ranging poll trigger frame, the response frame can be a clear-to-send to self (CTS-2-Self) frame, a protected M-BA frame, or a protected CTS-2-Self frame. Note that when the response frame is a protected M-BA frame, e.g., instead of a CTS-2-Self frame, the protected ranging poll trigger frame can be required to allocate a sufficient amount of time for a trigger based (TB) PPDU to accommodate the protected M-BA which is a larger frame than the CTS-2-Self frame. Note that a protected CTS-2-Self frame can be a CTS-2-Self frame that is expanded to include a packet number (PN) and/or MIC field in a TB PPDU. Note further that when the response frame is a protected CTS-2-Self frame, e.g., instead of a CTS-2-Self frame, the protected ranging poll trigger frame can be required to allocate a sufficient amount of time for a TB PPDU to accommodate the protected CTS-2-Self which is a larger frame than the CTS-2-Self frame.

In some instances, when the wireless station determines that the type, class, and/or format of the protected control frame is a protected ranging poll trigger frame that solicits response based on a ranging session identifier (RSID) assigned to the wireless station, the response frame can be a clear-to-send to self (CTS-2-Self) frame, a protected M-BA frame, or a protected CTS-2-Self frame that includes a MIC field. Note that when the response frame is a protected M-BA frame, e.g., instead of a CTS-2-Self frame, the protected ranging poll trigger frame can be required to allocate a sufficient amount of time for a trigger based (TB) PPDU to accommodate the protected M-BA which is a larger frame than the CTS-2-Self frame. Note that a protected CTS-2-Self frame can be a CTS-2-Self frame that is expanded to include a packet number (PN) and/or MIC field in a TB PPDU. Note further that when the response frame is a protected CTS-2-Self frame, e.g., instead of a CTS-2-Self frame, the protected ranging poll trigger frame can be required to allocate a sufficient amount of time for a TB PPDU to accommodate the protected CTS-2-Self which is a larger frame than the CTS-2-Self frame.

In some instances, when the wireless station determines that the type, class, and/or format of the protected frame is a protected ranging trigger frame, the response frame can be a frame as currently defined in current IEEE 802.11 specifications. For example, when the protected ranging trigger frame triggers secure sounding, the response frame can be a frame as currently defined in IEEE 802.11 for a secure ranging procedure protecting a ranging null data packet (NDP) frame. As another example, when the protected ranging trigger frame triggers reporting, the response frame can be a frame as currently defined in IEEE 802.11 for a secure ranging procedure protecting a location measurement report (LMR) frame. As an additional example, when the protected ranging trigger frame triggers passive sounding, the response frame can be a frame as currently defined in IEEE 802.11 for passive sounding, e.g., with a ranging NDP frame. Note that for non-trigger-based ranging procedures, the response frame can be an NDPA (null data packet announcement) frame and/or an NDP frame associated with the non-trigger-based ranging procedures as defined in current IEEE 802.11 specifications.

In some instances, the protected frame can be a protected buffer status report poll (BSRP) frame. The BSRP frame can include information associated with transmit opportunity sharing. The information associated with transmit opportunity sharing can include a duration of a transmit opportunity and/or a sharing mode of the transmit opportunity.

In some instances, the wireless station can determine that control frame protection is enabled and transmit, to the other wireless station, a protected buffer status report poll (BSRP) frame. In some instances, the protected BSRP frame can be transmitted for network allocation vector (NAV) protection and/or to initiate a transmit opportunity with the other wireless station (e.g., such as when the other wireless station is an access point operating dynamic power save (DPS) mode of operation). In some instances, the protected BSRP frame can solicit a response frame from the other wireless station, e.g., such as a protected M-BA frame aggregated with a QoS null frame. In such instances, the wireless station, upon receiving the protected M-BA frame aggregated with the QoS null frame, can attempt to decode the protected M-BA frame and the QoS null frame. Further, in some instances, the wireless station can determine that decoding of the protected M-BA frame has failed while decoding of the QoS null frame has succeeded. In such instances, the wireless station can discard the QoS null frame, treat the response frame as a failure, and discontinue transmissions to the other wireless station during a current transmit opportunity. Additionally, in some instances, the wireless station can determine that decoding of one of the protected M-BA frame or QoS null frame has succeeded. In such instances, the wireless station can treat decoding of the response frame as a success and continue transmissions to the other wireless station during a current transmit opportunity.

Turning to FIG. 8, as shown, this method can operate as follows.

At 802, a wireless station (e.g., such as wireless station 106 and/or AP 104) can transmit, to an other wireless station, a protected frame (e.g., a protected data frame, a protected management frame, and/or a protected control frame) soliciting a response from the other wireless station. The other wireless station can be a wireless station, such as wireless station 106. The protected frame can include a message integrity code (MIC) field. The protected frame can be received in a physical protocol data unit (PPDU). In addition, the protected frame can be aggregated with other frames in the PPDU. The protected frame can be a protected data frame, a protected management frame, a protected compressed block acknowledgement request (BAR) frame, a protected multiple traffic identifier (multi-TID) BAR frame, a protected multi-user BAR (MU-BAR) trigger frame, a protected Group Cast with Retries (GCR) (MU-BAR) trigger frame, a protected buffer status report poll (BSRP) trigger frame, a protected bandwidth query report poll (BQRP) trigger frame, a protected basic trigger frame, a protected beamforming report poll (BFRP) trigger frame, a protected Neighbor Discovery Protocol (NDP) feedback request poll (NFRP) frame, various protected frames aggregated with other medium access control (MAC) protocol data units (MPDUs), various protected frames aggregated with other PPDUs, and/or various protected frames associated with ranging.

At 804, the wireless station can receive, from the other wireless station, a response frame based, at least in part, on the type, class, and/or format of the protected frame. In some instances, when the response frame is a protected frame, the response frame can include a MIC field.

In some instances, when the type, class, and/or format of protected frame is any of a protected data frame, a protected management frame, a protected compressed BAR frame, a protected multi-TID BAR frame, a protected GCR MU-BAR trigger frame, and/or a protected MU-BAR trigger frame, the response frame can be a protected multi-user block acknowledgement (M-BA) frame (e.g., an M-BA frame enhanced/modified to include a MIC field).

In some instances, when the type, class, and/or format of the protected frame is any of a protected data frame, a protected management frame, a protected compressed BAR frame, a protected multi-TID BAR frame, a protected GCR MU-BAR trigger frame, and/or a protected MU-BAR trigger frame, the response frame can be further based on whether a block acknowledgement (blockack) session has been enabled. Further, when a blockack session has not been enabled, the response frame can be an acknowledgement frame or an M-BA enablement frame. Additionally, when a blockack session has been enabled, the response frame can be a protected M-BA frame.

In some instances, when the type, class, and/or format of the protected frame is a protected BSRP trigger frame and/or a protected BSRP trigger frame aggregated with other MPDUs, the response frame can be a protected M-BA frame, a protected M-BA frame aggregated with a Quality of Service (QoS) null frame, and/or a QoS null frame. Note that the BSRP trigger frame can solicit buffer status report (BSR) information and/or unavailability information. In some instances, such as when the response frame is a protected M-BA frame, the wireless station can embed the BSR into the protected M-BA frame. Further, BSR information, e.g., the embedded BSR, can include enhanced BSR information in an A-Control field and/or in a QoS Info Field of the M-BA frame. In addition, the protected M-BA frame can include other A-Control field information as well, such as a bandwidth query report (BQR) or an upstream power headroom (UPH). In some instances, such as when the response frame is a protected M-BA frame aggregated with a QoS null frame, if the wireless station only receives the QoS null frame from the other wireless station (e.g., the protected M-BA frame is not decoded successfully from the other wireless station, e.g., due to transmission errors and/or MIC verification errors), transmissions to the other wireless station can be aborted for a current transmission opportunity. In addition, the other wireless station can be required to place the protected M-BA frame at a beginning of an aggregate MPDU (AMPDU), e.g., to minimize risk of non-receipt of the protected M-BA frame. In other instances, if the wireless station (e.g., the soliciting wireless station) only receives one of the QoS null frame or protected M-BA frame, transmissions to the other wireless station can continue. In other words, as long as a frame is received from the other wireless station, transmissions to the other wireless station can continue in a current transmit opportunity. In some instances, such as when the response frame is a QoS null frame, the other wireless station can include the BSR in the QoS null frame. In such instances, the BSR can be protected if the QoS null frame is aggregated with a data frame or management frame with a no-acknowledgement option.

In some instances, when the type, class, and/or format of the protected control frame is a protected BQRP trigger frame and/or a protected BQRP trigger frame aggregated with other MPDUs, the response frame can be a protected M-BA frame. In some instances, the protected M-BA frame can include an embedded BQR. Further, BQR information, e.g., the embedded BQR, can include enhanced BQR information in an A-Control field and/or in a QoS Info Field of the M-BA frame. In addition, the protected M-BA frame can include other A-Control field information as well, such as a BSR or an upstream power headroom (UPH). In some instances, such as when the response frame is a protected M-BA frame aggregated with a QoS null frame, if the wireless station only receives the QoS null frame from the other wireless station (e.g., the protected M-BA frame is not decoded successfully from the other wireless station, e.g., due to transmission errors and/or MIC verification errors), transmissions to the other wireless station can be aborted for a current transmission opportunity. In addition, the other wireless station can be required to place the protected M-BA frame at a beginning of an aggregate MPDU (AMPDU), e.g., to minimize risk of non-receipt of the protected M-BA frame. In other instances, if the wireless station (e.g., the soliciting wireless station) only receives one of the QoS null frame or protected M-BA frame, transmissions to the other wireless station can continue. In other words, as long as a frame is received from the other wireless station, transmissions to the other wireless station can continue in a current transmit opportunity. In some instances, such as when the response frame is a QoS null frame, the other wireless station can include the BQR in the QoS null frame. In such instances, the BQR can be protected if the QoS null frame is aggregated with a data frame or management frame with a no-acknowledgement option. In some instances, if a receiver addressed by the response frame fails to decode the protected M-BA frame while succeeding in decoding the QoS null frame, the receiver can treat the response frame as a failure by discarding the QoS null frame, not trusting any information in the QoS null frame, and/or aborting a current transmit opportunity or treat the response frame as a success by continuing to decode the QoS null frame or transmitting a subsequent frame in the transmit opportunity based on the response frame.

In some instances, when the type, class, and/or format of the protected frame is a protected NFRP trigger and/or a protected NFRP frame aggregated with other MPDUs, the response frame can be a frame as currently defined in 802.11 specifications.

In some instances, when the type, class, and/or format of the protected frame is a protected basic trigger frame, the response frame can be at least a protected data frame, at least a protected management frame, and/or a protected M-BA frame aggregated with at least a protected data frame or a protected management frame. Additionally, In some instances, when the type, class, and/or format of the protected control frame is a protected basic trigger frame aggregated with other MPDUs, the response frame can be a protected M-BA frame, a protected M-BA frame aggregated together with a data frame, and/or a protected M-BA frame aggregated together with a management frame.

In some instances, when the type, class, and/or format of the protected frame is a protected BFRP trigger frame, the response frame can be an unprotected BFR frame (e.g., since an attacker cannot cause much harm via a fake BFR), a protected BFR, and/or a protected M-BA frame aggregated with an unprotected BFR frame.

In some instances, when the type, class, and/or format of the protected frame is a protected ranging poll trigger frame, the response frame can be a clear-to-send to self (CTS-2-Self) frame, a protected M-BA frame, or a protected CTS-2-Self frame. Note that when the response frame is a protected M-BA frame, e.g., instead of a CTS-2-Self frame, the protected ranging poll trigger frame can be required to allocate a sufficient amount of time for a trigger based (TB) PPDU to accommodate the protected M-BA which is a larger frame than the CTS-2-Self frame. Note that a protected CTS-2-Self frame can be a CTS-2-Self frame that is expanded to include a packet number (PN) and/or MIC field in a TB PPDU. Note further that when the response frame is a protected CTS-2-Self frame, e.g., instead of a CTS-2-Self frame, the protected ranging poll trigger frame can be required to allocate a sufficient amount of time for a TB PPDU to accommodate the protected CTS-2-Self which is a larger frame than the CTS-2-Self frame.

In some instances, when the type, class, and/or format of the protected control frame is a protected ranging poll trigger frame that solicits response based on a ranging session identifier (RSID) assigned to the wireless station, the response frame can be a clear-to-send to self (CTS-2-Self) frame, a protected M-BA frame, or a protected CTS-2-Self frame that includes a MIC field. Note that when the response frame is a protected M-BA frame, e.g., instead of a CTS-2-Self frame, the protected ranging poll trigger frame can be required to allocate a sufficient amount of time for a trigger based (TB) PPDU to accommodate the protected M-BA which is a larger frame than the CTS-2-Self frame. Note that a protected CTS-2-Self frame can be a CTS-2-Self frame that is expanded to include a packet number (PN) and/or MIC field in a TB PPDU. Note further that when the response frame is a protected CTS-2-Self frame, e.g., instead of a CTS-2-Self frame, the protected ranging poll trigger frame can be required to allocate a sufficient amount of time for a TB PPDU to accommodate the protected CTS-2-Self which is a larger frame than the CTS-2-Self frame.

In some instances, when the type, class, and/or format of the protected frame is a protected ranging trigger frame, the response frame can be a frame as currently defined in current IEEE 802.11 specifications. For example, when the protected ranging trigger frame triggers secure sounding, the response frame can be a frame as currently defined in IEEE 802.11 for a secure ranging procedure protecting a ranging null data packet (NDP) frame. As another example, when the protected ranging trigger frame triggers reporting, the response frame can be a frame as currently defined in IEEE 802.11 for a secure ranging procedure protecting a location measurement report (LMR) frame. As an additional example, when the protected ranging trigger frame triggers passive sounding, the response frame can be a frame as currently defined in IEEE 802.11 for passive sounding, e.g., with a ranging NDP frame. Note that for non-trigger-based ranging procedures, the response frame can be an NDPA (null data packet announcement) frame and/or an NDP frame associated with the non-trigger-based ranging procedures as defined in current IEEE 802.11 specifications.

In some instances, the protected frame can be a protected buffer status report poll (BSRP) frame. The BSRP frame can include information associated with transmit opportunity sharing. The information associated with transmit opportunity sharing can include a duration of a transmit opportunity and/or a sharing mode of the transmit opportunity.

In some instances, the wireless station can determine that control frame protection is enabled and transmit, to the other wireless station, a protected buffer status report poll (BSRP) frame. In some instances, the protected BSRP frame can be transmitted for network allocation vector (NAV) protection and/or to initiate a transmit opportunity with the other wireless station. In some instances, the protected BSRP frame can solicit a response frame from the other wireless station, e.g., such as a protected M-BA frame aggregated with a QoS null frame. In such instances, the wireless station, upon receiving the protected M-BA frame aggregated with the QoS null frame, can attempt to decode the protected M-BA frame and the QoS null frame. Further, in some instances, the wireless station can determine that decoding of the protected M-BA frame has failed while decoding of the QoS null frame has succeeded. In such instances, the wireless station can discard the QoS null frame, treat the response frame as a failure, and discontinue transmissions to the other wireless station during a current transmit opportunity. Additionally, in some instances, the wireless station can determine that decoding of one of the protected M-BA frame or QoS null frame has succeeded. In such instances, the wireless station can treat decoding of the response frame as a success and continue transmissions to the other wireless station during a current transmit opportunity.

Thus, according to the methods of FIGS. 7 and 8, it can be possible to respond to a protected frame soliciting a response in a WLAN setting, for example to provide enhanced security in the WLAN setting, among various possibilities. Such techniques can provide improved security for devices within the WLAN setting among a variety of possible benefits, at least according to some embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

In addition to the above-described exemplary embodiments, further embodiments of the present disclosure can be realized in any of various forms. For example, some embodiments can be realized as a computer-implemented method, a computer-readable memory medium, or a computer system. Other embodiments can be realized using one or more custom-designed hardware devices such as ASICs. Still other embodiments can be realized using one or more programmable hardware elements such as FPGAs.

In some embodiments, a non-transitory computer-readable memory medium can be configured so that it stores program instructions and/or data, where the program instructions, if executed by a computer system, cause the computer system to perform a method, e.g., any of the method embodiments described herein, or, any combination of the method embodiments described herein, or, any subset of any of the method embodiments described herein, or, any combination of such subsets.

In some embodiments, a device (e.g., an AP 104 or a STA 106) can be configured to include a processor (or a set of processors) and a memory medium, where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device can be realized in any of various forms.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method for responding to a protected frame, comprising:
receiving, from a wireless station, a protected frame soliciting a response;
determining at least one of a type, a class, or a format of the protected frame;
determining, based at least in part on the determined at least one of the type, the class, or the format of the protected frame, whether a response frame is to be transmitted as a protected frame; and
sending, to the wireless station, the response frame based on the determination of whether the response frame is to be transmitted as a protected frame.

2. The method of claim 1,
wherein the protected frame includes a message integrity code (MIC) field.

3. The method of claim 1,
wherein, when the protected frame is determined to be a protected data frame, a protected management frame, a protected compressed block acknowledgement request (BAR) frame, a protected multiple traffic identifier (multi-TID) BAR frame, a protected multi-user BAR (MU-BAR) trigger frame, or a protected Group Cast with Retries (GCR) MU-BAR trigger frame, the response frame is a protected multi-user block acknowledgement (M-BA) frame.

4. The method of claim 1,
wherein, when the protected frame is determined to be a protected buffer status report poll (BSRP) trigger frame or a protected BSRP trigger frame aggregated with at least one medium access control (MAC) protocol data unit (MPDU), the response frame is a protected multi-user block acknowledgement (M-BA) frame, a protected M-BA frame aggregated with a Quality of Service (QoS) null frame, or a QoS null frame.

5. The method of claim 4,
wherein a buffer status report (BSR) is carried in the protected M-BA frame.

6. The method of claim 5,
wherein one or more of a bandwidth query report (BQR) or an upstream power headroom (UPH) is carried in the protected M-BA frame.

7. The method of claim 4,
wherein the protected M-BA frame is carried at a start of an aggregated MAC protocol data unit (A-MPDU).

8. The method of claim 1,
wherein, when the protected frame is determined to be a protected bandwidth query report poll (BQRP) trigger frame or a protected BQRP trigger frame aggregated with at least one MAC protocol data unit (MPDU), the response frame is a protected multi-user block acknowledgement (M-BA) frame, a protected M-BA frame aggregated with a Quality of Service (QoS) null frame, or a QoS null frame.

9. The method of claim 8,
wherein a bandwidth query report (BQR) is carried in the protected M-BA frame.

10. The method of claim 9,
wherein one or more of a buffer status report (BSR) or an upstream power headroom (UPH) is carried in the protected M-BA frame.

11. A first wireless station, comprising:
one or more antennas;
one or more radios in communication with the one or more antennas; and
one or more processors in communication with the one or more radios, wherein the one or more processors are configured to cause the wireless station to:
receive, from a second wireless station, a protected frame soliciting a response;
determine at least one of a type, a class, or a format of the protected frame;
determine, based at least in part on the determined at least one of the type, the class, or the format of the protected frame, whether a response frame is to be transmitted as a protected frame; and
send, to the second wireless station, the response frame based on the determination of whether the response frame is to be transmitted as a protected frame.

12. The first wireless station of claim 11,
wherein, when the protected frame is determined to be a protected basic trigger frame, the response frame comprises at least one of: a protected data frame, a protected management frame, or a protected multi-user block acknowledgement (M-BA) frame aggregated with at least a protected data frame or a protected management frame.

13. The first wireless station of claim 11,
wherein, when the protected frame is determined to be a protected basic trigger frame or a protected basic trigger frame aggregated with at least one MAC protocol data unit (MPDU), the response frame is a protected multi-user block acknowledgement (M-BA) frame, a protected M-BA frame aggregated with at least one data frame, or a protected M-BA frame aggregated with at least one management frame.

14. The first wireless station of claim 11,
wherein, when the protected frame is determined to be a protected ranging poll trigger frame, the response frame is a clear-to-send to self (CTS-to-self) frame, a protected multi-user block acknowledgement (M-BA) frame, or a protected CTS-to-self frame that includes a message integrity code (MIC) field.

15. The first wireless station of claim 14,
wherein the protected ranging poll trigger frame allocates resources in a trigger-based physical protocol data unit (PPDU) to accommodate the protected M-BA or protected CTS-to-self.

16. A non-transitory computer-readable memory medium storing program instructions executable by one or more processors of a first wireless station to cause the first wireless station to:
receive, from a second wireless station, a protected frame soliciting a response;
determine at least one of a type, a class, or a format of the protected frame;
determine, based at least in part on the determined at least one of the type, the class, or the format of the protected frame, whether a response frame is to be transmitted as a protected frame; and
send, to the second wireless station, the response frame based on the determination of whether the response frame is to be transmitted as a protected frame.

17. The non-transitory computer-readable memory medium of claim 16,
wherein, when the protected frame is determined to be a protected ranging poll trigger frame that solicits a response from an unassociated station based on a ranging session identifier (RSID) assigned to the unassociated station, the response frame comprises a clear-to-send to self (CTS-to-self) frame, a protected M-BA frame, or a protected CTS-to-self frame.

18. The non-transitory computer-readable memory medium of claim 17,
wherein the protected ranging poll trigger frame allocates resources in a trigger-based physical protocol data unit (PPDU) to accommodate the protected M-BA or protected CTS-to-self.

19. The non-transitory computer-readable memory medium of claim 16,
wherein the program instructions are further executable by the one or more processors of the first wireless station to cause the first wireless station to:
receive a response frame comprising a protected multi-user block acknowledgement (M-BA) frame aggregated with a Quality of Service (QoS) null frame;
determine that decoding of the protected M-BA frame has failed while decoding of the QoS null frame has succeeded; and
discard the QoS null frame, treating the response frame as a failure, or stopping transmission to the wireless station in a current transmit opportunity.

20. The non-transitory computer-readable memory medium of claim 16,
wherein the program instructions are further executable by the one or more processors of the first wireless station to cause the first wireless station to:
receive a response frame comprising a protected multi-user block acknowledgement (M-BA) frame aggregated with a Quality of Service (QoS) null frame;
determine that decoding of at least one of the protected M-BA frame or the QoS null frame has succeeded; and
continue transmission to the wireless station in a current transmit opportunity.
